(19) United States
(12) Patent Application Publication
(10) Pub. No.: US 2010/0141705 A1
(43) Pub. Date: Jun. 10, 2010

(54) COMPACT WASTE INK ABSORBER FACILITATING FLUID EVAPORATION

(75) Inventor: Juan M. Jimenez, Escondido, CA (US)

Correspondence Address: EASTMAN KODAK COMPANY;PATENT LEGAL STAFF, 343 STATE STREET, ROCHESTER, NY, 14650-2201, US

(73) Assignee: Eastman Kodak Company

(21) Appl. No.: 12/329,935

(22) Filed: Dec. 8, 2008

(51) Int. Cl. B41J 2/165

(52) U.S. Cl. 347/31

(57) ABSTRACT

A waste ink absorber and evaporator for an inkjet printing system includes a body of porous capillary medium that wicks liquid ink to an outer surface having several corrugations that form an evaporative outer surface area of the body of porous capillary medium.

### FIELD OF THE INVENTION

The present invention relates generally to the handling of waste ink in an inkjet printer, and more particularly to a compact design for a waste ink absorber/evaporator.

### BACKGROUND OF THE INVENTION

An inkjet printing system typically includes one or more printheads and their corresponding ink supplies. Each printhead includes an ink inlet that is connected to its ink supply and an array of drop ejectors, each ejector including an ink chamber, an ejecting actuator and an orifice through which droplets of ink are ejected. The ejecting actuator may be one of various types, including a heater that vaporizes some of the ink in the chamber in order to propel a droplet out of the orifice, or a piezoelectric device which changes the wall geometry of the chamber in order to generate a pressure wave that ejects a droplet. The droplets are typically directed toward paper or other recording medium (sometimes generically referred to as paper herein) in order to produce an image according to image data that is converted into electronic firing pulses for the drop ejectors as the print medium is moved relative to the printhead.

Motion of the print medium relative to the printhead includes keeping the printhead stationary and advancing the print medium past the printhead while the drops are ejected. This architecture is appropriate if the nozzle array on the printhead can address the entire region of interest across the width of the print medium. Such printheads are sometimes called pagewidth printheads.

A second type of printer architecture is the carriage printer, where the printhead nozzle array is somewhat smaller than the extent of the region of interest for printing on the print medium and the printhead is mounted on a carriage. In a carriage printer, the print medium is advanced a given distance along a print medium advance direction and then stopped. While the print medium is stopped, the printhead carriage is moved in a direction that is substantially perpendicular to the print medium advance direction as the drops are ejected from the nozzles. After the carriage has printed a swath of the image while traversing the print medium, the print medium is advanced, the carriage direction of motion is reversed, and the image is formed swath by swath.

Inkjet ink includes a variety of volatile and nonvolatile components including pigments or dyes, humectants, image durability enhancers, and carriers or solvents. A key consideration in ink formulation is the ability to produce high quality images on the print medium. During periods when ink is not being ejected from an ejector, the volatile components of the ink can evaporate through the nozzle, or there can be other factors why the ink properties (such as viscosity) at the nozzle change. Such changes can make the drop ejection process nonuniform, so that the image quality can be degraded. In addition, dust, dried ink or other particulates can partially block a nozzle or make the wettability of the nozzle face around the nozzle nonuniform so that ejected drops can be misdirected from their intended flight paths.

In order to maintain the drop ejecting quality of the printhead so that high quality images are produced even after periods where one or more nozzles has been inactive, a variety of maintenance actions have been developed and are well known in the art. These maintenance actions can include capping the printhead nozzle face region during periods of nonprinting, wiping the nozzle face, periodically spitting drops from the nozzles into the cap or other reservoir that is outside the printing region, priming the nozzles by applying a suction pressure at the nozzle face, etc.

In order to remove excess ink from the cap due to spitting or priming, the waste ink is typically discharged into a waste pad region where the ink can accumulate and evaporate over the lifetime of the printer. The waste pad is generally made of a capillary material such as felt or open cell foam, and helps to keep the waste ink from spilling if the printer is moved. The waste pad can be located between the cap and intake of the vacuum pump that provides the suction pressure, as in U.S. Pat. No. 5,329,306, or it can be located at the discharge end of the pump.

The waste pad typically sits in a waste ink container such as a tray, as in U.S. Pat. No. 6,267,465, U.S. Pat. No. 6,659,587, U.S. Pat. No. 6,890,057, and U.S. Pat. No. 7,111,923. The thickness of the waste pad, as measured from its bottom side near the bottom of the container or tray to its top side is generally much less than its lateral dimensions. As an example, the height of the waste pad in the aforementioned art is about 10 to 15 mm, while its length and width can be on the order of 100 mm to 200 mm. Over the lifetime of the printer, several hundred milliliters of ink can be discharged into the waste pad region. The waste pad is designed to have sufficient volume to absorb or evaporate the ink that will be discharged from maintenance operations over the lifetime of the printer. Some of the ink components, such as the colorants or humectants do not evaporate appreciably. However, the volatile components, such as water or other solvents or carrier fluids do evaporate, particularly if the volatile components can be brought to an outside surface of the waste pad. Facilitating the evaporation of the volatile components can enable the use of a waste ink pad that is smaller than the total volume of ink that is discharged over the lifetime of the printer.

A thin and flat configuration of the waste pad is one conventional example. This provides a large surface area for evaporation. However, a known yet unsolved problem is that as the ink wicks through the waste pad and the volatiles evaporate, the remaining substance can become viscous, tar-like, or even dry and crusty. As a result, in some cases the waste ink pad area is not efficiently used, as ink is not able to distribute itself across the waste ink pad. U.S. Pat. No. 6,659,587 and U.S. Pat. No. 6,890,057 disclose features of the tray that facilitate spreading of the liquid ink in the bottom of the tray before it is absorbed into the waste pad, so that it spreads over a large area of the waste pad. U.S. Pat. No. 6,267,465 discloses a waste pad system including a first pad on top of a second pad, where the ink is discharged into the interface between the two pads, so that the volatile ink components are shielded from evaporation, until the ink can distribute itself more uniformrly across the ink pad area.

It is desired to make printers more and more compact. Compact printers take up less room on the user's work surface, and also can be shipped at lower cost per printer. It has been found in some compact printer designs that there is not room for a large flat waste ink pad.

What is needed is a more compact design of a waste ink absorber/evaporator that can accommodate the ink discharged due to maintenance operations over the lifetime of the printer through absorptive retention of the nonvolatile: ink components and the efficient transport of volatile ink components to the surface for evaporation.

### SUMMARY OF THE INVENTION

The aforementioned need is met by the present invention of a waste ink absorber and evaporator for an inkjet printing system that includes a body of porous capillary medium that wicks liquid ink to an outer surface having several corrugations that form an evaporative outer surface area of the body of porous capillary medium.

Another implementation of the present invention includes an inkjet printing system with a substantially horizontal wall and a waste ink absorber and evaporator, the waste ink absorber and evaporator being disposed on the substantially horizontal wall. The waste ink absorber and evaporator includes a body of porous capillary medium; and several corrugations disposed around the periphery of the body of porous capillary medium, thus forming a corrugated evaporative surface.

Another aspect of the present invention employs a method of forming a waste ink absorber and evaporator that includes the steps of:

providing a porous capillary medium;

providing an extrusion die, comprising a finned forming surface;

forcing the porous capillary medium through the extrusion die to form a body of porous capillary medium with a corrugated outer surface; and

cutting the extruded body of porous capillary medium to a predetermined dimension.

### BRIEF DESCRIPTION OF THE DRAWINGS

FIG. 1 schematically shows an inkjet printer system.

FIG. 2 shows a perspective view of a portion of a printhead chassis.

FIG. 3 is a perspective view of a portion of a carriage printer.

FIG. 4 is a schematic side view of a paper path in a carriage printer.

FIG. 5 shows a perspective view of an embodiment of a waste ink absorber and evaporator having fins and grooves forming a corrugated evaporative surface.

FIGS. 6A and 6B show perspective views of an embodiment of a waste ink absorber and evaporator sitting on a substantially horizontal wall of a printer.

FIGS. 7A to 7C show perspective views of a multi-channel ink dispersing fitting that distributes ink to an embodiment of a waste ink absorber and evaporator.

FIG. 8 shows a perspective view of an embodiment of a waste ink absorber and evaporator having offsetting adjacent portions of porous capillary medium forming a corrugated evaporative surface.

FIG. 9 shows a perspective view of an embodiment of a waste ink absorber and evaporator having windings and spaces forming a corrugated evaporative surface.

FIG. 10 schematically shows a top view of an embodiment of a waste ink absorber and evaporator having folds and spaces forming a corrugated evaporative surface.

### DETAILED DESCRIPTION OF THE INVENTION

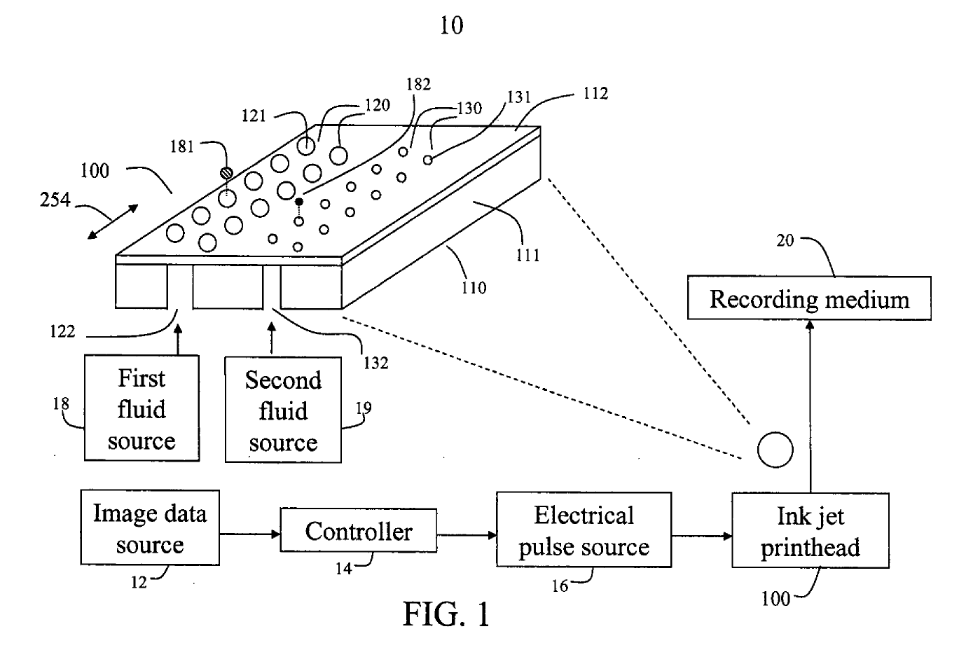

Referring to FIG. 1, a schematic representation of an inkjet printer system 10 is shown, and is further described in U.S. Pat. No. 7,350,902, yet is incorporated by reference herein in its entirety. The system includes a source 12 of image data which provides signals that are interpreted by a controller 14 as being commands to eject drops. Controller 14 outputs signals to a source 16 of electrical energy pulses that are inputted to the inkjet printhead 100 that includes at least one printhead die 110. In the example shown in FIG. 1, there are two nozzle arrays provided on a nozzle face (or nozzle plate) 112 formed on substrate 111 of printhead die 110. Nozzles 121 in the first nozzle array 120 have a larger opening area than nozzles 131 in the second nozzle array 130. Nozzle arrays 120 and 130 extend along array direction 254. In this example, each of the two nozzle arrays has two staggered rows of nozzles, each row having a nozzle density of 600 per inch. The effective nozzle density then in each array is 1200 per inch. If pixels on the recording medium were sequentially numbered along the paper advance direction, the nozzles from one row of an array would print the odd numbered pixels, while the nozzles from the other row of the array would print the even numbered pixels.

In fluid communication with each nozzle array is a corresponding ink delivery pathway. Ink delivery pathway 122 is in fluid communication with nozzle array 120, and ink delivery pathway 132 is in fluid communication with nozzle array 130. Portions of fluid delivery pathways 122 and 132 are shown in FIG. 1 as openings through printhead die substrate 111.

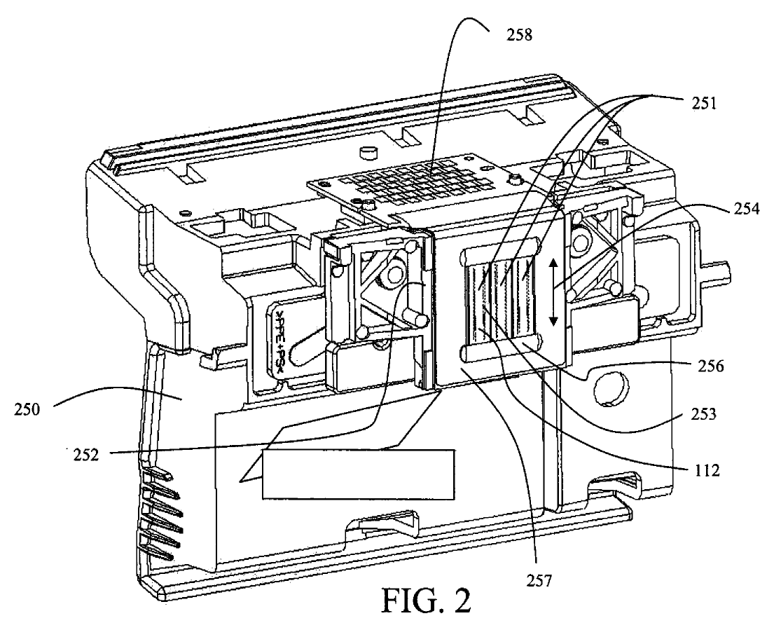

One or more printhead die 110 will be included in inkjet printhead 100, but only one printhead die 110 is shown in FIG. 1. The printhead die are arranged on a mounting support as discussed below relative to FIG. 2. In FIG. 1, first ink source 18 supplies ink to first nozzle array 120 via ink delivery pathway 122, and second ink source 19 supplies ink to second nozzle array 130 via ink delivery pathway 132. Although distinct ink sources 18 and 19 are shown, in some applications it may be beneficial to have a single ink source supplying ink to nozzle arrays 120 and 130 via ink delivery pathways 122 and 132 respectively. Also, in some embodiments, fewer than two or more than two nozzle arrays may be included on printhead die 110. In some embodiments, all nozzles on a printhead die 110 may be the same size, rather than having multiple sized nozzles on a printhead die.

Not shown in FIG. 1 are the drop forming mechanisms associated with the nozzles. Drop forming mechanisms can be of a variety of types, some of which include a heating element to vaporize a portion of ink and thereby cause ejection of a droplet, or a piezoelectric transducer to constrict the volume of a fluid chamber and thereby cause ejection, or an actuator which is made to move (for example, by beating a bilayer element) and thereby cause ejection. In any case, electrical pulses from pulse source 16 are sent to the various drop ejectors according to the desired deposition pattern. In the example of FIG. 1, droplets 181 ejected from nozzle array 120 are larger than droplets 182 ejected from nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on a recording medium 20.

FIG. 2 shows a perspective view of a portion of a printhead chassis 250, which is an example of an inkjet printhead 100. Printhead chassis 250 includes three printhead die 251 (similar to printhead die 110), each printhead die containing two nozzle arrays 253 formed on a nozzle face 112, so that printhead chassis 250 contains six nozzle arrays 253 altogether. The six nozzle arrays 253 in this example may be each connected to separate ink sources (not shown in FIG. 2), such as cyan, magenta, yellow, text black, photo black, and a colorless protective printing fluid.

The three printhead die 251 are mounted on mounting substrate 252 such that each of the six nozzle arrays 253 is disposed along array direction 254. The length of each nozzle array along direction 254 is typically on the order of 1 inch or less. Typical lengths of recording media are 6 inches for photographic prints (4 inches by 6 inches), or 11 inches for 8.5 by 11 inch paper. Thus, in order to print the full image, a number of swaths are successively printed while moving printhead chassis 250 across the recording medium. Following the printing of a swath, the recording medium is advanced.

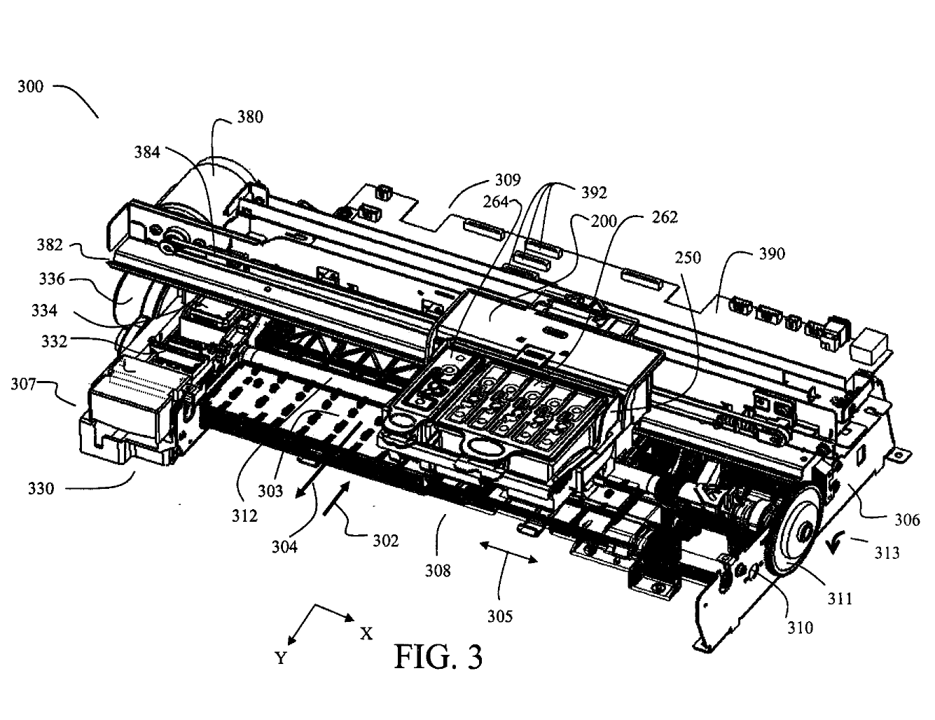

Also shown in FIG. 2 is a flex circuit 257 to which the printhead die 251 are electrically interconnected, for example by wire bonding or TAB bonding. The interconnections are covered by an encapsulant 256 to protect them. Flex circuit 257 bends around the side of printhead chassis 250 and connects to connector board 258. When printhead chassis 250 is mounted into the carriage 200 (see FIG. 3), connector board 258 is electrically connected to a connector (not shown) on the carriage 200, so that electrical signals may be transmitted to the printhead die 251.

FIG. 3 shows a portion of a carriage printer. Some of the parts of the printer have been hidden in the view shown in FIG. 3 so that other parts may be more clearly seen. Printer chassis 300 has a print region 303 across which carriage 200 is moved back and forth in carriage scan direction 305 along the X axis between the right side 306 and the left side 307 of printer chassis 300 while printing. Carriage motor 380 moves belt 384 to move carriage 200 back and forth along carriage guide rail 382. Printhead chassis 250 is mounted in carriage 200, and ink supplies 262 and 264 are mounted in the printhead chassis 250. The mounting orientation of printhead chassis 250 is rotated relative to the view in FIG. 2, so that the printhead die 251 are located at the bottom side of printhead chassis 250, the droplets of ink being ejected downward onto the recording media in print region 303 in the view of FIG. 3. Ink supply 262, in this example, contains five ink sources cyan, magenta, yellow, photo black, and colorless protective fluid, while ink supply 264 contains the ink source for text black.

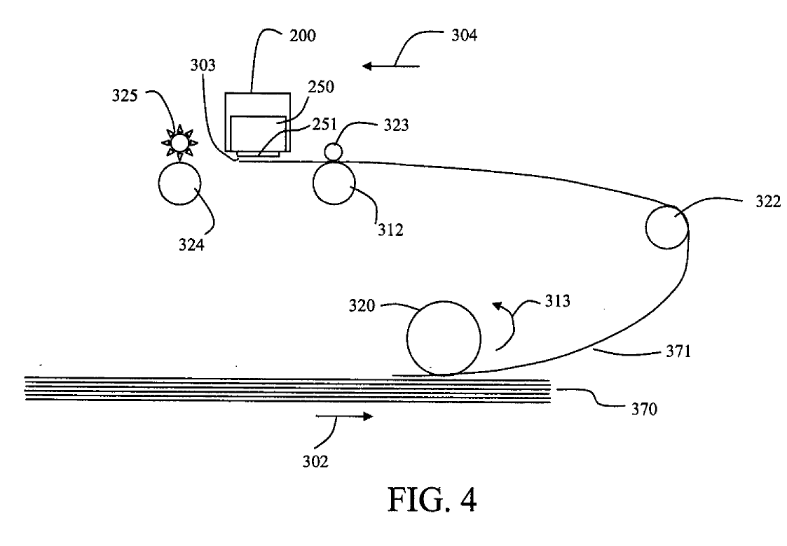

Paper, or other recording media (sometimes generically referred to as paper herein) is loaded along paper load entry direction 302 toward the front 308 of printer chassis 300. A variety of rollers are used to advance the medium through the printer, as shown schematically in the side view of FIG. 4. In this example, a pickup roller 320 moves the top sheet 371 of a stack 370 of paper or other recording media in the direction of arrow 302. A turn roller 322 toward the rear 309 of the printer chassis 300 acts to move the paper around a C-shaped path (in cooperation with a curved rear wall surface) so that the paper continues to advance along direction arrow 304 from the rear 309 of the printer. The paper is then moved by feed roller 312 and idler roller(s) 323 to advance along the Y axis across print region 303, and from there to a discharge roller 324 and star wheel(s) 325 so that printed paper exits along direction 304. Feed roller 312 includes a feed roller shaft 319 along its axis, and feed roller gear 311 is mounted on the feed roller shaft 319. Feed roller 312 may consist of a separate roller mounted on feed roller shaft 319, or may consist of a thin high friction coating on feed roller shaft 319. The motor that powers the paper advance rollers is not shown in FIG. 3, but the hole 310 at the right side 306 of the printer chassis 300 is where the motor gear (not shown) protrudes through in order to engage feed roller gear 311, as well as the gear for the discharge roller (not shown). For normal paper pick-up and feeding, it is desired that all rollers rotate in forward direction 313.

Toward the rear 309 of the printer in the example of FIG. 3 is located the electronics board 390, which contains cable connectors 392 for communicating via cables (not shown) to the printhead carriage 200 and from there to the printhead. Also on the electronics board are typically mounted motor controllers for the carriage motor 380 and for the paper advance motor, a processor and/or other control electronics for controlling the printing process, and an optional connector for a cable to a host computer.

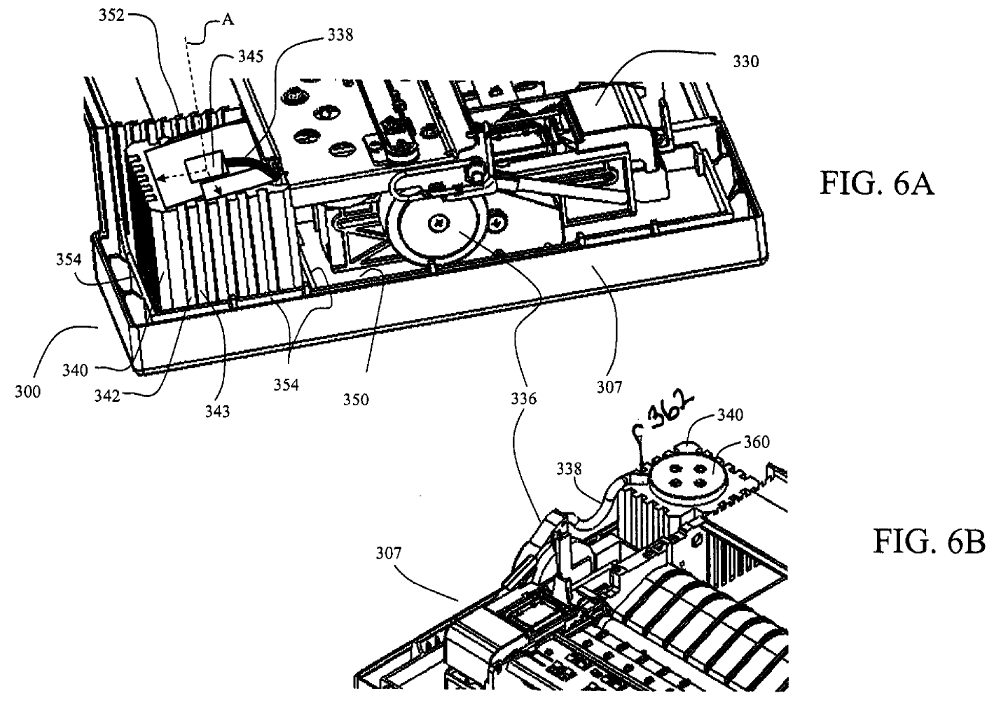

Toward the left side 307 in the example of FIG. 3 is the maintenance station 330. Maintenance station 330 includes wiper blade assembly 332, cap assembly 334, and pump 336. Pump 336 can be a peristaltic or tube pump for example. The intake of pump 336 is connected to cap assembly 334. The discharge from pump 336 is carried by a waste ink hose 338 (see FIG. 6B) to a waste ink area (not shown in FIG. 3).

Embodiments of the present invention include a body of porous capillary medium (e.g. felt or open-cell foam) used as a waste ink absorber and evaporator that wicks liquid ink to an outer surface having a plurality of corrugations to increase the surface area for evaporation of the volatile components of the ink. The term “corrugations” is used herein to include ridges, folds, projections, grooves, windings, spaces, fins, or other such shapes that extend from or indent into the body of porous capillary medium, to expose more of the surface of the body to air. As a result of the increase of surface area of the body due to the corrugations, the overall shape of the body can be more block-like, rather than a long, wide and thin pad, and still promote evaporation of the volatile components of the ink. The block-like extent of the body enables it to be placed in a small footprint region of the printer.

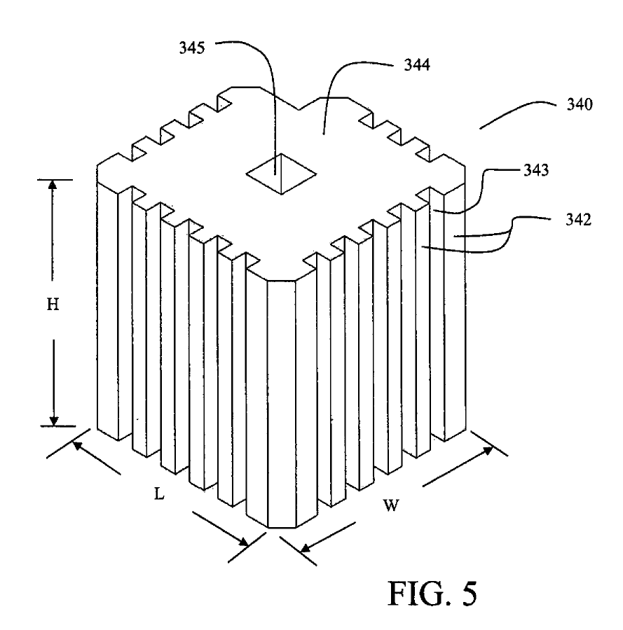

FIG. 5 shows a first embodiment of the present invention. Waste ink absorber and evaporator (also sometimes referred to herein as waste ink absorber) 340 has the shape of a block with fins 342 alternating with grooves 343 around the sides of the block. The height H of waste ink absorber 340 is measured from a top face 344 to a bottom face (not shown). The fins 342 and grooves 343 are oriented substantially parallel to the height dimension. An open region 345 can be provided in the interior of waste ink absorber 340. In FIG. 5 the open region extends from the top face 344 to the bottom face. The lateral dimensions of the block are its length L and its width W. In a particular example sized to fit an available space in a compact inkjet printer, and also sized to accommodate the waste ink discharged throughout the lifetime of the printer, the height H and length L are each 60 mm, and the width W is 55 mm. The fins 342 have a cross-section of 4 mm by 4 mm, and the grooves have a similar cross-section. Thus, the body of porous capillary media is approximately cube-shaped overall. It is not necessarily or strictly required that the length, width and height of waste ink absorber 340 be substantially equal. However, in order to fit into available space in a compact printer, typically the height H is such that 0.5 L<H<2 L, and 0.5 W<H<2 W.

FIGS. 6A and 6B show an embodiment where the waste ink absorber 340 sits on its bottom face on a substantially horizontal wall 350 toward the left side 307 (relative to the orientation of FIG. 3) of printer chassis 300. The waste ink absorber 340 shown in FIGS. 6A and 6B is the same type that is shown in FIG. 5, although for purpose of clarity, its dimensions H, L and W are not labeled. Its body of porous capillary medium has a plurality of corrugations (fins 342 and grooves 343) disposed around the periphery of the body, to form a corrugated evaporative surface. The corrugations (the fins 342 and grooves 343 in this example) extend along a direction that is perpendicular to the substantially horizontal wall 350, i.e. they are oriented parallel to height dimension H. The body of porous capillary medium includes a central axis A that is perpendicular to the substantially horizontal wall 350, and a plurality of corrugations (i.e. the fins 342) project outwardly away from axis A, for example, in the directions indicated by the dashed arrows in FIG. 6A.

Optionally, the horizontal wall 350 can be partitioned off (e.g. by containment walls 354 shown in FIG. 6A) from the rest of the printer chassis in order to form an enclosed tray for waste ink to reside in prior to being absorbed into waste ink absorber 340. The discharge end of waste ink hose 338 of the pump 336 of maintenance station 3 30 is located adjacent to a surface of the body of porous capillary medium of waste ink absorber 340. In some embodiments, as shown schematically in FIG. 6A, the discharge end of the waste ink hose 338 is positioned adjacent to open region 345 in the interior of the body of porous capillary medium. In some embodiments, such as that shown in FIG. 6B, the discharge end of the waste ink hose 338 is connected to a hose fitting 362 of a multi-channel ink dispersing fitting 360.

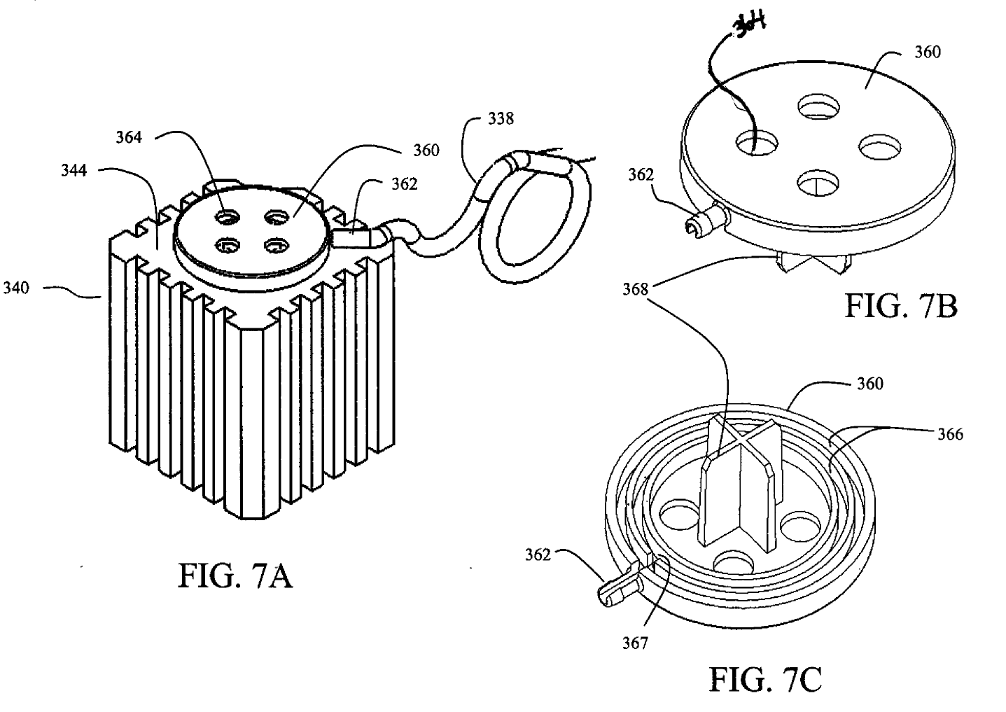

FIGS. 7A-7C show additional views of the embodiment of FIG. 6B where the discharge end of the waste ink hose 338 is connected to a hose fitting 362 of a multi-channel ink dispersing fitting 360. FIG. 7A shows the multi-channel ink dispersing fitting 360 assembled to waste ink absorber 340. FIG. 7B shows the multi-channel ink dispersing fitting 360 (rotated relative to FIG. 7A) before assembly to waste ink absorber 340. Anchor 368 extends from the underside of multi-channel ink dispersing fitting 360 and presses against the walls of open region 345 of the body of porous capillary medium when assembled. Anchor 368 thus secures the discharge end of the waste ink hose 338 (connected to hose fitting 362) to the body of porous capillary medium. In the example of FIG. 7, anchor 368 has the shape of a cross, as is seen more clearly in the underside view of FIG. 7C. Also shown in FIG. 7C are a plurality of concentric channels 366 that are fluidically connected to hose fitting 362. When waste ink is discharged into hose fitting 362, the waste ink is distributed around the upper face 344 of waste ink absorber 340. Ink can travel from outer channel to the inner channel through opening 367, and the ink can also travel around both channels to provide multiple entry points for waste ink to enter waste ink absorber 340. Optionally, multi-channel ink dispersing fitting 360 also includes one or more vents 364 as illustrated in FIGS. 7A and 7B.

Inkjet inks can include on the order of 65% to 85% volatile components such as water or other carrier fluid. In order to efficiently use the volume of the body of porous capillary medium of waste ink absorber 340, it is advantageous to promote evaporation of the volatile components. When the waste ink is discharged from pump 336 and contacts waste ink absorber 340, the ink wicks into and through the waste ink absorber 340 by capillary action. An advantage of a configuration for waste ink absorber 340 such as that shown in FIGS. 5-7 is that the discharged waste ink does not need to wick very far until it reaches an outer surface of the body (also called an evaporative outer surface) to promote evaporation by contact with air. A second advantage of the configuration of FIGS. 5-7 is that there are many parallel paths for the discharged waste ink to reach the evaporative outer surface. Thus, over time, as some paths become clogged with viscous ink residue, there are still other capillary paths for volatile components to reach the evaporative outer surface of the waste ink absorber and evaporator 340.

Some amount of evaporation of volatile ink components can occur even within the body of porous capillary medium rather than at its surface. However, evaporation is faster at the evaporative outer surface. If the air in contact with a liquid already has a high concentration of the substance evaporating, then the given substance will evaporate more slowly. The air within the body of porous capillary medium is more saturated with the vapor of the volatile components (e.g. water vapor in the case of an aqueous based ink) than the outside air is. The air flow within the body of porous capillary medium is small compared to the air flow outside the body of porous capillary medium. If fresh air is moving over the waste ink (as it does at the outer evaporative surface of waste ink absorber and evaporator 340), then the concentration of the volatile components in the air is less likely to increase with time, thus encouraging faster evaporation. Air flow in the printer can result from thermal currents due to heat generated by the printer, from motion of printer components such as the carriage 200, and in some cases from a fan inside the printer. In order to facilitate the flow of air near portions of waste ink absorber and evaporator 340 that are near other printer components, at least one air vent 352 can be provided near the body of porous capillary medium. In the example shown in FIG. 6, vents 352 are provided as a group of parallel grooves in the wall of a nearby printer component.

There are a variety of ways for making different shapes of waste ink absorbers 340 having a plurality of corrugations forming an evaporative outer surface of the body of porous capillary medium. For the embodiment shown in FIG. 5, one method is to force a body of porous capillary medium (such as a body of felted fibers) through an extrusion die having a forming surface to form the fins 342 and grooves 343. Then the extruded body is cut to a predetermined dimension (e.g. height H) to form the faces 344. The optional open region 345 can be formed before, during or after the extrusion step that forms the corrugated outer surface. The process of extruding the body of felted fibers causes a substantial alignment of the fibers along the extrusion direction, i.e. along the height dimension of waste ink absorber and evaporator 340, or (with reference to FIG. 6A) the fibers are substantially perpendicular to the substantially horizontal wall 350. This does not mean that all fibers are aligned along height dimension H. For structural integrity, the fibers need to cross one another. However, the fibers are more aligned along H than if the body of felted fibers had not been extruded. An advantage of such an alignment of fibers in this embodiment is that it promotes more wicking of the waste ink along the height dimension, so that the full height of the waste ink absorber and evaporator 340 is more efficiently used in storing and evaporating waste ink.

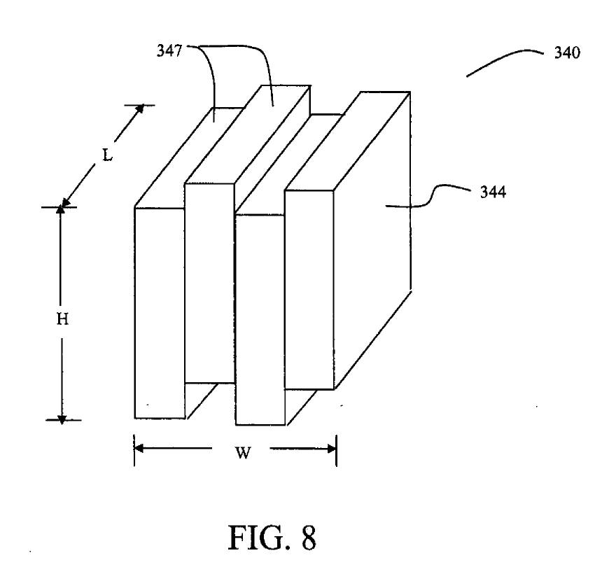

A second embodiment of the waste ink absorber and evaporator 340 of the present invention is shown in FIG. 8. In this embodiment a plurality of pieces of porous capillary medium are assembled adjacent to, but offset from one another, so that the body of porous capillary medium has offsetting portions 347. These offsetting portions 347 can be held together by fibers that extend between adjacent offsetting portions 347, for example. The example shown in FIG. 8 shows offsets along height dimension H, but there can also be offsets along length dimension L, for example. The orientation of the waste ink absorber 340 shown in FIG. 8 is an example of a waste ink absorber 340 that sits on its corrugated surface formed by the offsetting portions 347, rather than on a face 344.

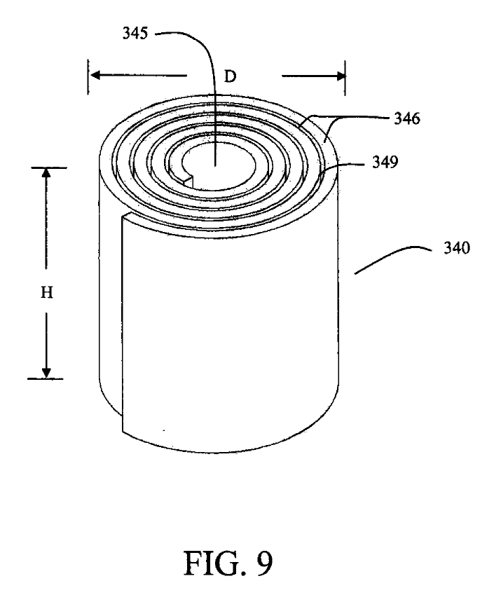

A third embodiment of the waste ink absorber and evaporator 340 of the present invention is shown in FIG. 9. In this embodiment, a sheet of porous capillary medium, such as felt or open cell foam, is rolled into a spiral roll having a plurality of windings 346, where adjacent windings 346 are separated by spaces 349. In this embodiment the windings 346 and spaces 349 form the corrugated outer surface of the body of porous capillary medium. Open region 345 is located at the center of the spiral roll. In some embodiments, the sheet of capillary medium is loosely rolled and optionally circumferentially constrained at the outer winding 346, such that the tendency of the sheet to regain a flat shape results in the spaces 349 and open region 345. In other embodiments, pieces of spacer material (not shown) are intermittently positioned on the sheet prior to rolling, in order to provide the spaces 349 between adjacent windings 346. The spiral roll of this embodiment has a height H, and a diameter D. In some embodiments, in order to fit into available space in a compact printer, the height H is such that 0.5 D<H<2 D.

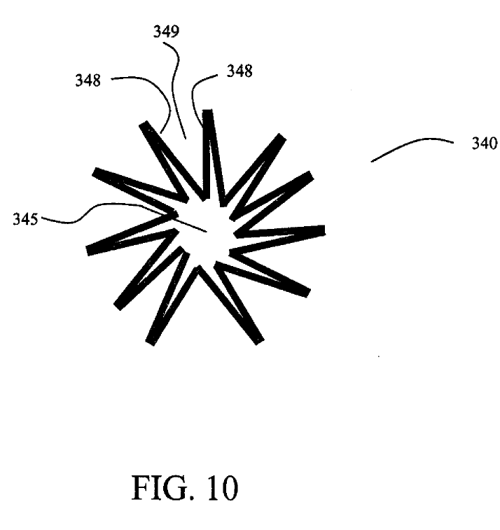

A fourth embodiment of the waste ink absorber and evaporator 340 of the present invention is shown schematically in the top view of FIG. 10. In this embodiment, a sheet of porous capillary medium, such as felt or open cell foam, is folded back and forth to form a somewhat star-shaped body of porous capillary medium, where adjacent folds 348 are separated by spaces 349. In some embodiments, the tendency of the sheet to regain a flat shape results in the spaces 349 and open region 345. In this embodiment, the folds 348 and spaces 349 form the corrugated outer surface of the body of porous capillary medium. The star-shaped body of porous capillary medium has a height H and a lateral extent S. In some embodiments, in order to fit into available space in a compact printer, the height H is such that 0.5 S<H<2 S.

The term “extent” is used herein to refer to a dimension such as a length, a width, a diameter, or other dimension that describes the overall lateral size of the body of porous capillary medium in a direction that is perpendicular to the height H of the waste ink absorber and evaporator 340. In typical embodiments, the height H is greater than 25 mm and less than 100 mm, while the extent S is less than 75 mm. In printer configurations where the waste ink absorber and evaporator is disposed on a substantially horizontal wall 350 as discussed above with reference to FIG. 6A, the height is considered to be the dimension that is perpendicular to the substantially horizontal wall 350, and the extent S is a dimension that is parallel to the substantially horizontal wall 350.

The invention has been described in detail with particular reference to certain preferred embodiments thereof; but it will be understood that variations and modifications can be effected within the spirit and scope of the invention.

### PARTS LIST

10 Inkjet printer system
12 Image data source
14 Controller
16 Electrical pulse source
18 First fluid source
19 Second fluid source
20 Recording medium
100 Ink jet printhead
110 Ink jet printhead die
111 Die substrate
112 Nozzle face
120 First nozzle array
121 Nozzle in first nozzle array
122 Ink delivery pathway for first nozzle array
130 Second nozzle array
131 Nozzle in second nozzle array
132 Ink delivery pathway for second nozzle array
181 Droplet ejected from first nozzle array
182 Droplet ejected from second nozzle array
200 Carriage
250 Printhead chassis
251 Printhead die
252 Mounting substrate
253 Nozzle array
254 Nozzle array direction
255 Mounting surface of mounting substrate
256 Encapsulant
257 Flex circuit
258 Connector board
262 Multichamber ink supply
263 Nozzle plate face of printhead die
264 Single chamber ink supply
300 Printer chassis
302 Paper load entry
303 Print region
304 Paper exit
306 Right side of printer chassis
307 Left side of printer chassis
308 Front portion of printer chassis
309 Rear portion of printer chassis
310 Hole for paper advance motor drive gear
311 Feed roller gear
312 Feed roller
313 Forward rotation of feed roller
319 Feed roller shaft
320 Pickup roller
322 Turn roller
323 Idler roller
324 Discharge roller
325 Star wheel
330 Maintenance station
332 Wiper blade assembly
334 Cap assembly
336 Pump
338 Waste ink discharge hose
340 Waste ink absorber and evaporator
342 Fin
343 Groove
344 Face
345 Open region
346 Winding
347 Offsetting portion
348 Fold
349 Spaces
350 Wall
352 Air vent
354 Containment wall
360 Multi-channel ink dispersing fitting
362 Hose fitting
364 Vent
366 Channels
367 Opening
368 Anchor
370 Stack of media
371 Top sheet
380 Carriage motor
382 Carriage rail
384 Belt
390 Printer electronics board
392 Cable connectors

1. A waste ink absorber and evaporator for an inkjet printing system, the waste ink absorber and evaporator comprising: a body of porous capillary medium that wicks liquid ink to an outer surface having a plurality of corrugations forming an evaporative outer surface area of the body of porous capillary medium.

2. The waste ink absorber and evaporator claimed in claim 1, the body including a length L, a width W and a height H, wherein 0.5 L<H<2 L and 0.5 W<H<2 W.

3. The waste ink absorber and evaporator claimed in claim 1, the body including a diameter D and a height H, wherein 0.5 D<H<2 D.

4. The waste ink absorber and evaporator claimed in claim 1, wherein the corrugations include extruded fins.

5. The waste ink absorber and evaporator claimed in claim 4, the porous capillary medium comprising fibers, wherein the fibers are substantially aligned along the height dimension of the waste ink absorber and evaporator.

6. The waste ink absorber and evaporator claimed in claim 1, wherein the corrugations comprise offsetting adjacent portions of porous capillary medium.

7. The waste ink absorber and evaporator claimed in claim 1, the body including a plurality of folds or windings of porous capillary medium, wherein the corrugations comprise the folds or windings of porous capillary medium.

8. The waste ink absorber and evaporator claimed in claim 1, wherein a height H of the waste ink absorber and evaporator is less than 100 mm.

9. An inkjet printing system comprising a substantially horizontal wall and a waste ink absorber and evaporator, the waste ink absorber and evaporator being disposed on the substantially horizontal wall, wherein the waste ink absorber and evaporator comprises:
a body of porous capillary medium; and
a plurality of corrugations disposed around the periphery of the body of porous capillary medium, thus forming a corrugated evaporative surface.

10. The inkjet printing system claimed in claim 9, the waste ink absorber and evaporator including a height H that is perpendicular to the substantially horizontal wall and an extent S that is parallel to the surface of the substantially horizontal wall, wherein 0.5 S<H<2 S.

11. The inkjet printing system claimed in claim 10, wherein S<75 mm and H>25 mm and <100 mm.

12. The inkjet printing system claimed in claim 9, wherein a plurality of corrugations extend along a direction that is perpendicular to the substantially horizontal wall.

13. The inkjet printing system claimed in claim 9, the body of porous capillary medium including a central axis that is perpendicular to the substantially horizontal wall, wherein a plurality of corrugations project outwardly away from the axis.

14. The inkjet printing system claimed in claim 9, the body of porous capillary medium comprising fibers that are substantially aligned perpendicular to the substantially horizontal wall.

15. The inkjet printing system claimed in claim 10, further comprising a maintenance station including a waste ink hose, wherein an end of the waste ink hose is disposed adjacent to a surface of the body of porous capillary medium.

16. The inkjet printing system claimed in claim 15, wherein the waste ink hose is held by a multi-channel ink dispersing fitting.

17. The inkjet printing system claimed in claim 15, the body of porous capillary including an open region in its interior, wherein the end of the waste ink hose is disposed adjacent to the open region in the interior of the body of porous capillary medium.

18. The inkjet printing system claimed in claim 15, further comprising an anchor that secures the waste ink hose to the body of porous capillary medium.

19. The inkjet printing system claimed in claim 15, further comprising at least one air vent proximate to the body of porous capillary medium.

20. A method of forming a waste ink absorber and evaporator, comprising the steps of:
providing a porous capillary medium;
providing an extrusion die, comprising a finned forming surface;
forcing the porous capillary medium through the extrusion die to form a body of porous capillary medium with a corrugated outer surface; and
cutting the extruded body of porous capillary medium to a predetermined dimension.
